(19) United States
(12) Patent Application Publication
(10) Pub. No.: US 2026/0079882 A1
(43) Pub. Date: Mar. 19, 2026

(54) SYSTEMS AND METHODS FOR CONCURRENT METADATA AND DATA PROCESSING IN INTERACTIVE DATA INGESTION

(71) Applicant: Salesforce, Inc., San Francisco, CA (US)

(72) Inventors: Anantharaman GANESH, San Jose, CA (US); Ravishankar ARIVAZHAGAN, Union City, CA (US); Sreeram Kumar GARLAPATI, Bothell, CA (US); Srinivas TIRUPATI, Bothell, WA (US)

(21) Appl. No.: 19/031,265

(22) Filed: Jan. 17, 2025

Related U.S. Application Data
(60) Provisional application No. 63/695,154, filed on Sep. 16, 2024.

(51) Int. Cl. G06F 16/11; G06F 16/14

(52) U.S. Cl. CPC G06F 16/116; G06F 16/148

(57) ABSTRACT

A data ingestion system processes data files through a dual-path architecture to enable rapid interactive data analysis. The system routes incoming files below a size threshold to a fast conversion path and larger files to a batch processing path. For files in the fast path, the system concurrently processes metadata and data instead of following traditional sequential processing. A metadata controller assigns storage locations and manages table definitions while a direct format converter transforms source files into query-ready columnar format. A query processor provides unified access to converted data across both processing paths. The system reduces processing latency by eliminating batch processing overhead for small files, enables immediate data querying through coordinated storage management, and maintains data consistency through stateful job tracking. This architecture enables rapid processing for interactive analysis while preserving robust batch processing capabilities for larger datasets.

### RELATED APPLICATIONS

This application claims priority to U.S. Provisional Application Ser. No. 63/695,154, filed Sep. 16, 2024, entitled “Self-Service Ingestion Pipeline,” which is incorporated by reference herein in its entirety.

### TECHNICAL FIELD

The disclosed implementations relate generally to data ingestion in distributed computing environments and more specifically to systems, methods, and architectures that enable concurrent processing of metadata and data for interactive data analysis applications.

### BACKGROUND

Data ingestion systems are critical components of modern data analysis platforms, enabling organizations to load and process data from various sources for analysis. Conventional systems were primarily designed for processing large volumes of data through batch operations, utilizing infrastructure like Apache Spark for data transformation and loading. These systems follow a strict sequential process where metadata about the data source must be created and synchronized across system components before actual data ingestion can begin. While this sequential batch approach effectively handles large data volumes, it creates significant challenges for interactive data analysis scenarios where analysts need to explore smaller datasets quickly, often working with files under 10 megabytes. Some systems attempt to address this by maintaining separate pipelines for different data volumes, but these approaches typically result in disconnected data silos and inconsistent processing logic. Other solutions try to optimize the batch pipeline for smaller files, but the fundamental sequential nature of metadata and data processing remains a bottleneck, creating unnecessary delays that interrupt the analytical workflow.

### SUMMARY

Accordingly, there is a need for a data ingestion system that can efficiently handle interactive analysis scenarios while maintaining compatibility with existing batch processing capabilities and ensuring consistent data processing across all ingestion paths. The disclosed system solves the problem of slow data ingestion for interactive analysis by introducing a dual-path architecture that intelligently routes data based on file size. For smaller files typically used in interactive analysis, the system processes data through a fast conversion path that operates concurrently with metadata setup, rather than sequentially as in traditional systems. This fast path uses a specialized conversion service that directly transforms data into a query-ready format without the overhead of batch processing systems, while larger files continue through a traditional batch processing path. Some implementations include a coordinated system of components working together. The system includes a control router that directs files to appropriate processing paths, a direct format converter that transforms data rapidly, a metadata controller that manages storage locations and table definitions, and a query processor that provides unified data access. This architecture enables analysts to start querying their smaller datasets within seconds of upload while maintaining robust processing capabilities for larger datasets, all without creating separate data silos or sacrificing processing consistency.

The disclosed system provides several technical improvements over conventional data ingestion systems. First, it reduces system resource utilization by eliminating the need to spin up heavyweight batch processing infrastructure for small files, instead using a lightweight conversion service that achieves the same data quality with significantly less computational overhead. Second, the concurrent processing of metadata and data reduces overall system latency (e.g., by up to 80% for files under 10 megabytes), achieved through state management that maintains data consistency without requiring sequential processing. Third, the system improves storage efficiency by coordinating storage location assignments before data conversion begins, eliminating the need for temporary storage locations and reducing storage operation costs.

Additional technical benefits include reduced network bandwidth consumption through targeted data movement, improved system scalability through independent scaling of fast and batch processing paths, and enhanced system reliability through stateful job management that enables precise recovery from failures. The system's unified query interface also reduces application complexity by abstracting the underlying processing paths, resulting in simplified client implementations and reduced maintenance overhead. These improvements are achieved through specific technical implementations rather than merely following conventional approaches at a higher speed.

In accordance with some implementations, a data ingestion system includes a control router configured to receive file processing requests and routes files under a size threshold to a direct conversion path and route files over the size threshold to a batch conversion path. The data ingestion system also includes a direct format converter configured to receive source data files from the control router and transform the source data files into platform-specific columnar files at assigned storage locations. The data ingestion system also includes a metadata controller configured to assign storage locations to the direct format converter, track the storage locations, and update table definitions upon completion of transformation of the source data files. The data ingestion system also includes a query processor configured to access the platform-specific columnar files using the storage locations from the metadata controller and provide data access as soon as direct format conversion completes the transformation of the source data files, while maintaining unified access to data transformed by the direct format converter and data converted in the batch conversion path. The direct format converter and metadata controller are further configured to operate concurrently through coordinated storage location handoffs.

In some implementations, the control router is further configured to determine the conversion path based on measured file sizes and user-specified processing parameters.

In some implementations, the direct format converter is further configured to perform in-memory columnar data transformation.

In some implementations, the metadata controller is further configured to maintain a state table tracking conversion status across concurrent operations.

In some implementations, the direct format converter is further configured to generate unique identifiers for each row during conversion.

In some implementations, the metadata controller is further configured to reserve storage paths before conversion begins and track path availability.

In some implementations, the metadata controller is further configured to execute both overwrite and append operations for converted data.

In some implementations, the metadata controller is further configured to transition through states comprising path reserved, commit pending, overwrite success, and overwrite failure.

In some implementations, the direct format converter is further configured to validate schema consistency between source and destination formats.

In some implementations, the metadata controller is further configured to validate schema consistency between the table metadata and the schema in the destination file format.

In some implementations, the control router is further configured to manage file re-upload scenarios by directing updates to existing storage locations.

In some implementations, the query processor is further configured to support remote file refresh through app-driven, query-layer-driven, and periodic refresh mechanisms.

In some implementations, the direct format converter is further configured to perform schema inference on source files before conversion.

In some implementations, the metadata controller is further configured to maintain cross-references between source files and converted files using unique identifiers.

In some implementations, the direct format converter is further configured to execute within a containerized environment supporting horizontal scaling.

In some implementations, the metadata controller is further configured to generate temporary credentials for storage access during conversion.

In some implementations, the query processor is further configured to maintain shadow extracts for remote file sources.

In some implementations, he metadata controller is further configured to generate paths and update table definitions concurrently.

In some implementations, the control router is further configured to process both synchronous and asynchronous conversion requests.

Typically, an electronic device includes one or more processors, memory, a display, and one or more programs stored in the memory. The programs are configured for execution by the one or more processors and are configured to perform any of the methods described herein.

In some implementations, a non-transitory computer-readable storage medium stores one or more programs configured for execution by a computing device having one or more processors, and memory. The one or more programs are configured to perform any of the methods described herein.

Thus, methods and systems are disclosed that allow rapid interactive data analysis through a dual-path ingestion architecture, accomplished by concurrent metadata and data processing, intelligent file routing based on size thresholds, direct format conversion for smaller files, and unified query access across processing paths, resulting in significantly reduced processing latency while maintaining data consistency and processing reliability across the system.

Both the foregoing general description and the following detailed description are exemplary and explanatory and are intended to provide further explanation of the invention as claimed.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Description of Implementations below, in conjunction with the following drawings in which like reference numerals refer to corresponding parts throughout the figures.

FIG. 1 is a block diagram of an example system for concurrent metadata and data processing in interactive data ingestion, according to some implementations.

FIG. 2 is a block diagram illustrating example components and process flow for uploading a file, according to some implementations.

FIG. 3 is a block diagram illustrating example components and process flow for schema analysis and data preview, according to some implementations.

FIG. 4 is a block diagram illustrating example components and process flow for configuring data streams and fast data ingestion, according to some implementations.

FIG. 5 is a sequence diagram of an example process for decoupled file format conversion based on file size, according to some implementations.

FIG. 6 is a sequence diagram of an example process for performing fast ingestion, according to some implementations.

FIG. 7 is a flow diagram of an example process for creating data lake objects, according to some implementations.

FIG. 8 is a flow diagram of an example process flow for managing state tables for data lake objects, according to some implementations.

FIG. 9 is a flow diagram of an example process flow for overwriting data lake objects, according to some implementations.

FIG. 10 is a block diagram of an example computing device for concurrent metadata and data processing in interactive data ingestion, according to some implementations.

FIG. 11 is a flowchart of an example method for data ingestion, according to some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

The various methods and devices disclosed in the present specification improve the efficiency and performance of data ingestion systems by reducing computational overhead through selective processing paths, eliminating sequential processing bottlenecks through concurrent metadata and data handling, and enabling immediate data querying through coordinated storage management, thereby advancing the technical field of distributed data processing systems beyond conventional batch-oriented architectures.

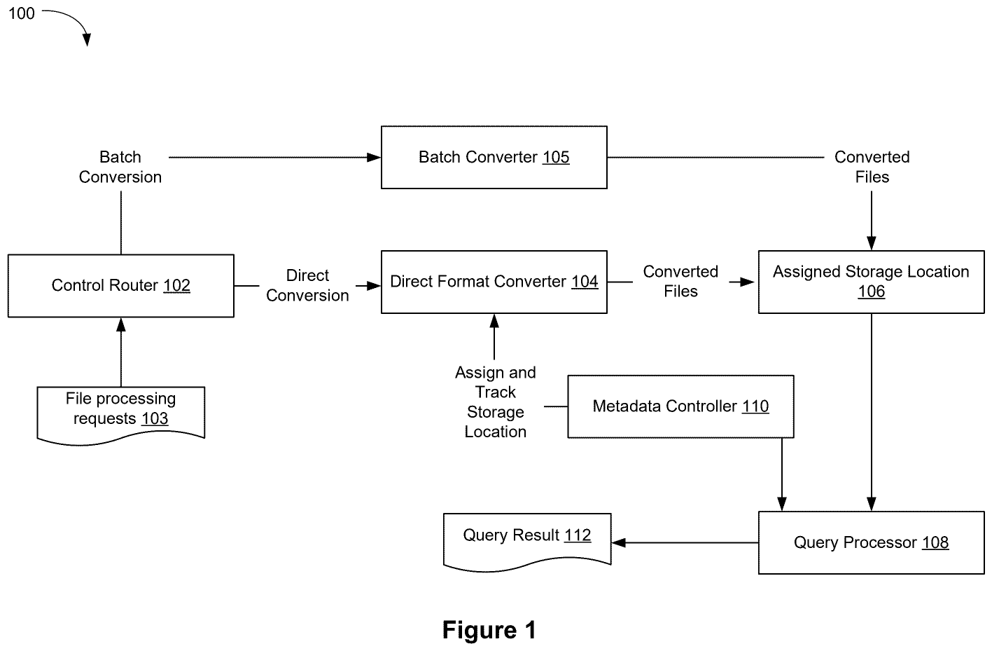

FIG. 1 is a block diagram of an example system 100 for concurrent metadata and data processing in interactive data ingestion, according to some implementations. In some implementations, a control router 102 receives one or more file processing requests 103 for one or more source files. Based on a size of a source file, the control router 102 may route the source file to a direct format converter 104 or a batch converter 105. For example, based on a determination that a size of a first source file is less than a file size threshold, the control router 102 routes the first source file to the direct format converter 104. In another example, based on a determination that a size of a second source file is greater than the file size threshold, the control router 102 routes the second source file to the batch converter 105.

In some implementations, the direct format converter 104 sends the converted files to an assigned storage location 106. The direct format converter 104 may write directly to the assigned storage location 106 (e.g., without intermediary modules, thereby increasing the operational speed of the ingestion process via the direct format converter). The direct format converter 104 may convert the source file to a Parquet file format. The converted file may be added to a metadata (e.g., a metadata stored in an open table format for large analytic datasets, such as Apache Iceberg).

In some implementations the schema of the Parquet file format is defined using Apache Arrow or Apache Avro. Arrow vectors are columnar data structures that hold data in a columnar format. Such Arrow vectors are efficient for both in-memory processing and serialization/deserialization tasks (especially for large data sets) and provides support for vectorized operations. The Arvo schema is a JSON-based definition that describes the structure of the data and includes information about the data types, fields, and relationships. Arvo enables support for schema evolution. Additionally, the Arvo schema is a row-oriented format.

In some implementations, the direct format converter is configured to convert files under a file size threshold. For example, the direct format converter converts files under the file size threshold within an interval less than a few seconds (e.g., less than 5 seconds). In some implementations, the direct format converter 104 may be configured to convert files quicker than the batch converter 105. In some implementations, the batch converter 105 sends the converted files to an assigned storage location 106.

The batch converter 105 represents the traditional data ingestion path optimized for processing large files (e.g., files over 10 MB). When the control router 102 receives a file processing request 103, it evaluates the file size. If the file exceeds the size threshold, it routes the file to the batch converter 105 instead of the direct format converter 104. The batch converter 105 uses an infrastructure (e.g., a scalable infrastructure like Apache Spark) for data transformation and loading, following a sequential approach where metadata must be fully processed before data transformation can begin. While this makes it slower than the direct format converter 104, it provides robust processing capabilities needed for large datasets. In some implementations, the batch converter 105 receives source files from the control router 102 and uses data streams to perform ingestion operations. In some implementations, the batch converter 105 transforms source files into the required format (such as Parquet) and sends the converted files to assigned storage locations 106. In some implementations, the batch converter 105 works with the metadata controller 110 for storage coordination and ensures the converted data is available to the query processor 108. In some implementations, the batch converter 105 prioritizes reliable processing of large datasets over speed, making it suitable for non-interactive scenarios where immediate data access isn't required. In this dual-path architecture of the system 100, each converter is optimized for different use cases based on file size and processing requirements.

In some implementations, both the direct format converter 104 and the batch converter 105 utilize a data stream to perform the ingestion (e.g., converting the source file to a different file format and stitching the converted file to the Iceberg metadata) and to perform upload and download functionalities from cloud storage scenarios. (e.g., push the file from local storage). For example, the data stream uploads (e.g., pushes) the file from local storage to cloud storage, and the data stream downloads (e.g., pulls) the file from cloud storage to local storage. In some implementations, the data stream download is configured to execute periodically (e.g., a batched operation).

In some implementations, a metadata controller 110 assigns storage locations to the direct format converter 104. The metadata controller 110 may also track the storage locations and update table definitions upon completion of transformation of the source data files to the converted data files (which may be stored in the assigned storage location 106).

In some implementations, the metadata controller 110 concurrently creates metadata as the direct format converter 104 converts the file. In this way, ingestion speed may be increased by removing a dependency and ordering between the creation of metadata associated with the file to be ingested and conversion and/or storage of the ingested file.

In some implementations, the query processor 108 retrieves the converted files from the assigned storage location 106. The query processor 108 processes the query and outputs a query result 112.

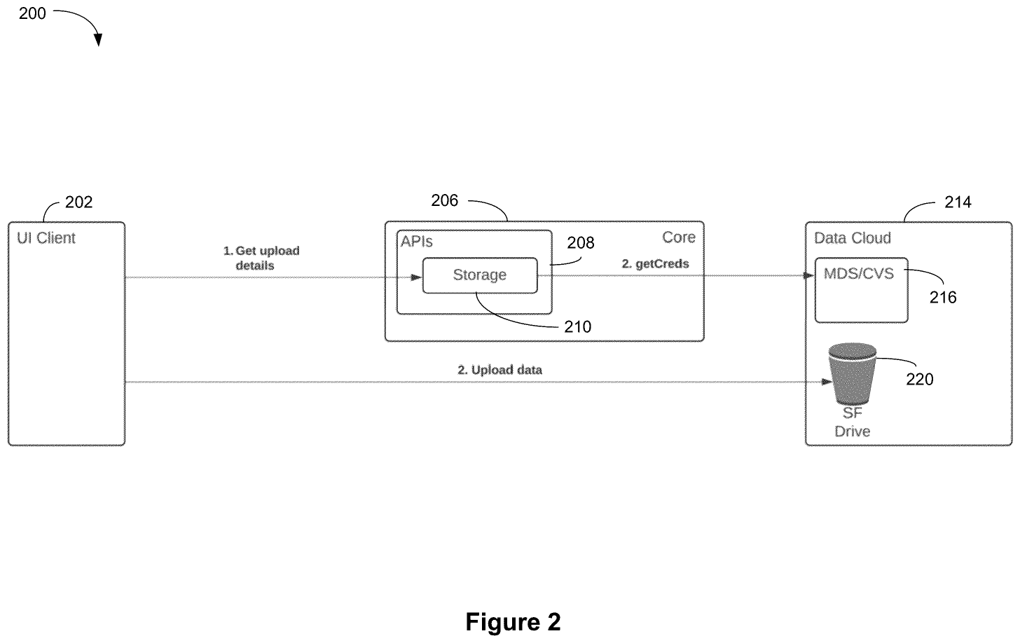

FIG. 2 is a block diagram illustrating example components and process flow 200 for uploading a file, according to some implementations. In some implementations, upload details regarding the file (example of the file processing requests 103) are uploaded to a core 206 (e.g., the control router 102) via a user interface (UI) client 202. The UI client 202 receives upload details to a storage via a storage application programming interfaces (APIs) 210, which is one of a plurality of APIs 208. The APIs 208 (including the storage API 210) are associated with (and/or stored in) the core 206.

In some implementations, based on upload details associated with the source file, the core 206 and/or the storage API 210 retrieve credential information (e.g., temporary S3 credentials) and send (e.g., via a S3 software development kit) the credential information to a metadata controller 216 (e.g., a metadata service, the metadata controller 110), which may be hosted in a data cloud 214. In some implementations, the metadata controller 216 is a near-core service (e.g., the metadata controller 216 is separate from the core 206).

In some implementations, the UI client 202 uploads data associated with the source file to an assigned storage location 220 (e.g., the assigned storage location 106), which may be hosted in the data cloud 214. The core 206 (e.g., via the storage API 210) may validate that a user has the appropriate permissions before uploading data. For example, as shown in FIG. 2, a source file that is received at the UI client 202 is uploaded to “SF Drive” (the assigned storage location 220). The assigned storage location 220 may include a set of data cloud (DC)-internal S3 buckets that have a DC-tenant-sharded prefix-paths to which files can be uploaded. In some implementations, after the file is uploaded to the S3 bucket, it is available to the data cloud 214 like any other file on any other storage location.

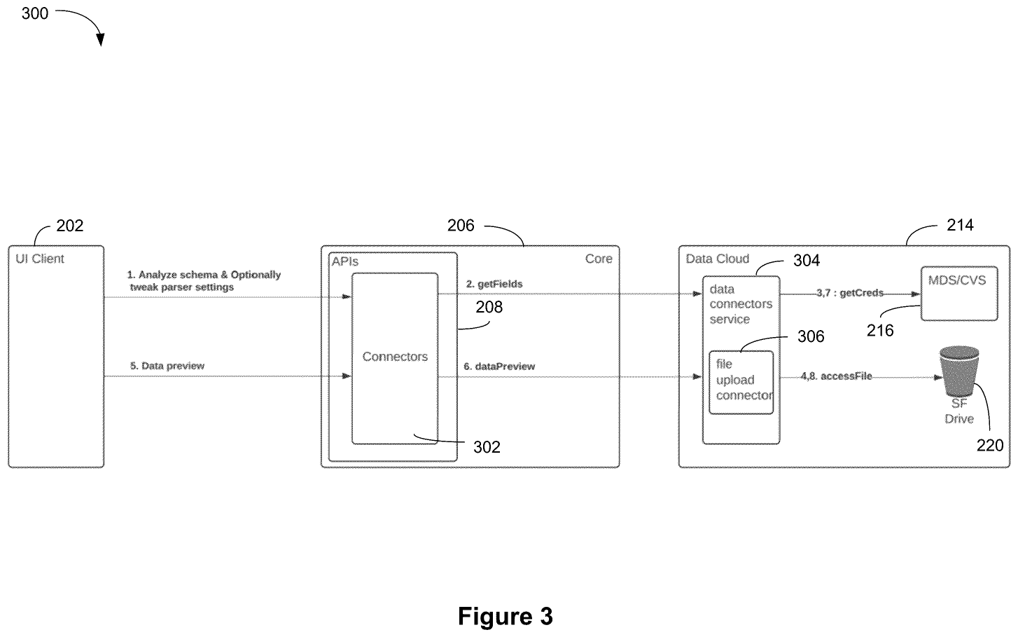

FIG. 3 is a block diagram illustrating example components and process flow 300 for schema analysis and data preview, according to some implementations. As shown in FIG. 3, the UI client 202 requests (e.g., in step (1)) analysis of a schema of the uploaded file via one or more connector APIs 302, which is one of the plurality of APIs 208. The one or more connector APIs retrieves (e.g., in step (2)) one or more fields from a data connectors service 304 (e.g., a data connectors framework) of the data cloud 214. The data connectors service 304 hosts a file upload connector 306, which is a way to access the uploaded files stored in the assigned storage location 120. The data connectors service 304 and/or the file upload connector 306 requests (e.g., in step (3)) credentials from the metadata controller 216. In accordance with a determination that appropriate credentials are received from the metadata controller 216, the data connectors service 304 and/or the file upload connector 306 accesses (e.g., in step (4)) the uploaded file from the assigned storage location 220 to provide the fields for schema analysis requested by the UI client 202.

In some embodiments, in addition to, or instead of, the schema analysis of the uploaded file, the UI client 202 updates parser settings via the one or more connector APIs 302.

In some implementations, the UI client 202 requests (e.g., in step (8)) a data preview of the uploaded file via the one or more connector APIs 302. The one or more connector APIs 302 retrieve (e.g., in step (6)) a data preview of the uploaded file from the data connectors service 304 and/or the file uploaded connector 306. The data connectors service 304 and/or the file upload connector 306 requests credentials (e.g., in step (7)) from the metadata controller 216. In accordance with a determination that appropriate credentials are received from the metadata controller 216, the data connectors service 304 and/or the file upload connector 306 accesses (e.g., in step (8)) the uploaded file from the assigned storage location 220 to provide the data preview requested by the UI client 202.

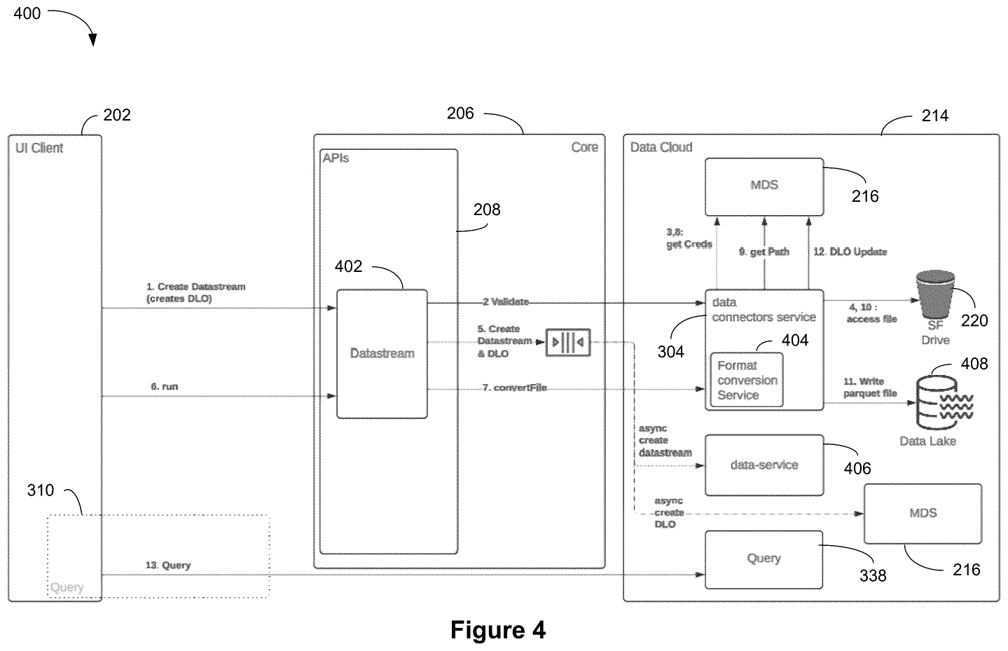

FIG. 4 is a block diagram illustrating example components and process flow 400 for configuring data streams and fast data ingestion, according to some implementations. In some implementations, the UI client 202 requests (e.g., in step (1)) creation of a data stream and/or a data lake object (DLO) via Data Stream API 402, which is one of the plurality of APIs 208. A data lake object (DLO) refers to a metadata management entity that maintains table definitions, tracks storage locations, and/or manages the lifecycle of data files in a data lake environment. A data lake environment refers to a centralized storage system that allows organizations to store, manage, and/or analyze large volumes of structured and unstructured data in its native format until needed for processing. The data stream and the DLO may have entity relationships. The data stream API 402 requests (e.g., in step (2)) validation from the data connectors service 304, which may include a format conversion service 404. The data connectors service 304 requests (e.g., in step (3)) credentials from the metadata controller 216. In accordance with a determination that appropriate credentials are received from the metadata controller 216, the data connectors service 304 accesses (e.g., in step (4)) the uploaded file in the assigned storage location 220.

In some implementations, the data stream definition includes schedule=Never, a connection identifier (ID) of a connection for the data connectors service 304 and a file path to the assigned storage location 220, a parser configuration, fields metadata of data stream, and/or other data stream metadata.

In some embodiments, the file upload connector 306 checks the size of the uploaded file. If the file size is greater than a threshold file size (e.g., greater than 10 MB), the data stream creation process will terminate (e.g., fail to create a data Stream and/or DLO). If the file size is less than a threshold file size (e.g., less than or equal to 10 MB) the data stream creation process proceeds.

In some implementations, the data stream API 402 creates (e.g., in step (5)) a data stream and/or a DLO in the core 206. A data stream may be asynchronously created at a data service 406, and a DLO may be asynchronously created at the metadata controller 216. As noted above with respect to FIG. 2, in some implementations, the metadata controller 216 is a near-core service (e.g., the metadata controller 216 is separate from the core 206). As such, the respective data stream and DLO is asynchronously synchronized between the core 206 and the near-core (e.g., the metadata controller 216). In some implementations, the data service 406 will not automatically run the data stream job because the data stream schedule is set to never.

In some implementations, the UI client 202 requests (e.g., in step (8)) a file conversion via the data stream API 402 that converts (e.g., in step (7)) the uploaded file via a direct format converter 404 (e.g., a format conversion service, the direct format converter 104). The request for file conversion may originate from a Tableau Unified Analytics (TUA), Tableau Einstein application, or a similar application. Additionally, the data stream API may receive a core data stream identifier and/or API Name and/or interactive or regular mode as inputs. In response to the call to the data stream API 402, the data stream API 402 may read the data stream definition and corresponding DLO definition from the core 206. These definitions are provided to the direct format converter 404. Next, the data connectors service 304 and/or the file upload connector 306 requests (e.g., in step (9)) credentials and the file path from the metadata controller 216. In accordance with a determination that appropriate credentials and a valid file path are received from the metadata controller 216, the data connectors service 304 and/or the file upload connector 306 accesses (e.g., in step (10)) the uploaded file in the assigned storage location 220. The file upload connector 306 may read tuples from the uploaded file and return the data to the direct format converter 404. The uploaded file is converted by the direct format converter 404 to a Parquet file that is then written (e.g., in step (11)) to a data lake 408. For example, the direct format converter 404 converts a CSV file to a Parquet file and then writes the Parquet file to the data lake 408.

In some implementations, prior to writing the converted file to the data lake 408, the direct format converter 404 invokes an API associated with the metadata controller 216 to acquire a path to the data lake 408 that the direct format converter 404 should write the converted file to. In some implementations, if a DLO has not been created, the metadata controller 216 will generate a table path for the DLO and will keep track of that path in a relational database service (RDS) for state tracking for the metadata controller (sometimes referred to as metadata service or MDS) for a future DLO creation call to use. If a DLO has already been created, the metadata controller 216 will return the already generated table path for the DLO.

In some implementations, after successfully writing the converted file to the data lake 408, the direct format converter 404 (sometimes referred to as the format conversion service) will invoke a second API associated with the metadata controller 216 to perform an metadata operation to overwrite a table (e.g., a table stored in a data lake house architecture that combines elements of both data lakes and data warehouses) with the converted file. In some implementations, synchronization of corresponding DLOs between the core 206 and the metadata controller 216 is not required. If the corresponding DLOs are not synchronized, the metadata controller 216 will note that the uploaded file has been created, and once DLO creation happens, the metadata controller 216 will commit using the uploaded file for the DLO (e.g., the respective DLO stored in the core 206).

In some implementations, when the uploaded file has been successfully written to the data lake 408, a query 310 can be submitted (e.g., in step (13)) via the UI client 202 to a query service 338 (e.g., the query processor 108), which may be hosted in the data cloud 214, for analysis of at least the data of the converted file.

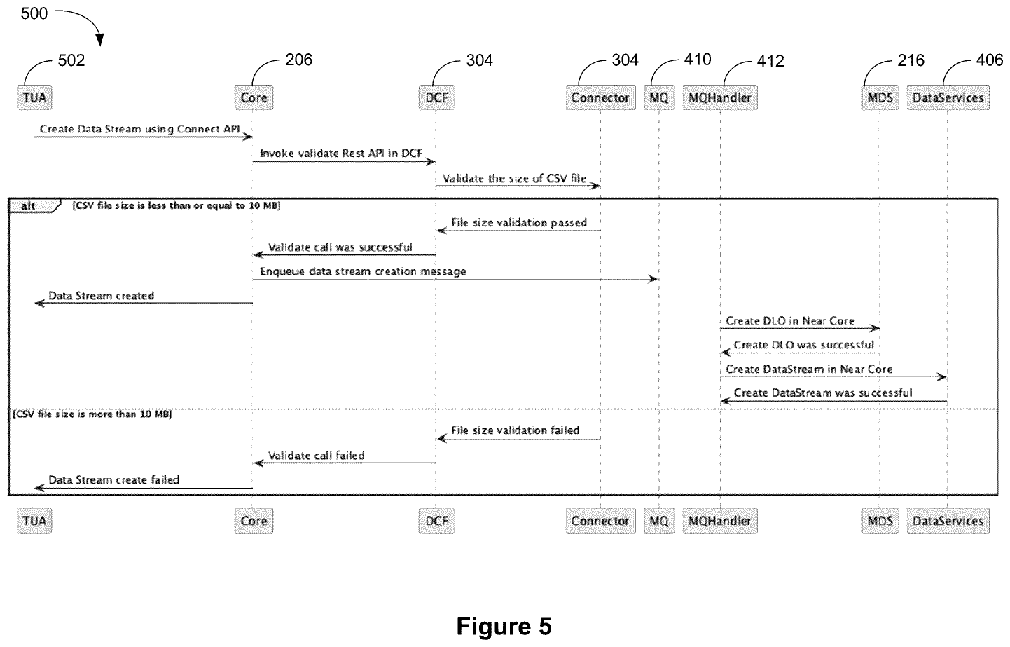

FIG. 5 is a sequence diagram of an example process 500 for decoupled file format conversion based on file size, according to some implementations. In some implementations, an analytics framework 502 (e.g., Tableau Unified Analytics, sometimes referred to as TUA) creates a data stream using a connector API, via the core 206. In some implementations, the core 206 invokes a validate REST API in the data connectors service 304 (which may be part of the near-core) to validate a source file using the file name and parser settings that are configured in the data stream. The data connectors service 304 may delegate the validate call to a specific implementation in the file upload connector 306 to check the file size and/or any other validations. For example, if a source CSV file is greater than a 10 MB, the data stream creation fails, and the core 206 lets the TUA know that the data stream creation failed. In another example, if a source CSV file is less than or equal to 10 MB, the data stream is created successfully via the data service 406 in the near-core and/or created in the core 206. In some implementations, the data stream creation message is enqueued to a message queue (MQ) 410. After the enqueueing, the core 206 lets the TUA 502 know that data stream is created. A message queue handler 412 creates the DLO in the near core via the metadata controller 216. The message queue handler 412 also creates a data stream in the data services 406.

In some implementations, a DLO corresponding to the data stream is created in a database of the core 206 and/or near-core. The DLO may be relationally linked to the data stream. The data stream may be marked as inactive and the DLO may be marked as processing to indicate that they are not ready to be used.

In some implementations, before the data stream create call returns, the core 206 enqueues a message into the MQ 410 (sometimes referred to as a core MQ or CoreMQ) to replicate the data stream and the DLO definitions to near-Core (e.g., to the metadata controller 216).

In some implementations, the data stream and DLO are marked ACTIVE whenever the CoreMQ handler 412 runs. The execution of the CoreMQ message handler 412 is distinct from the data stream creation call.

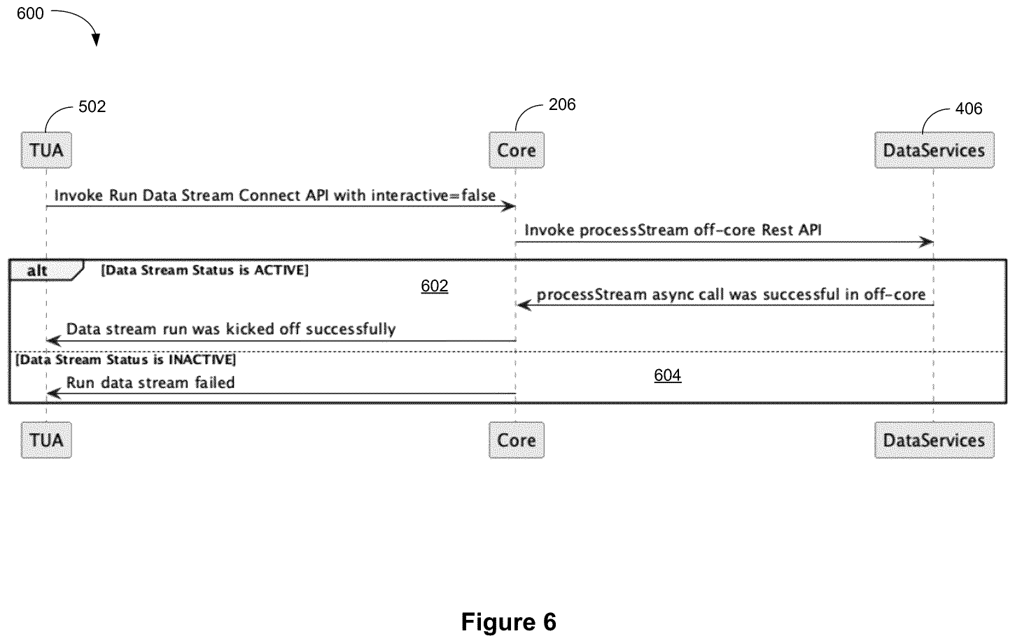

FIG. 6 is a sequence diagram of an example process 600 for performing fast ingestion, according to some implementations. In some implementations, the TUA 502 invokes a run data stream connect API at the core 206, for example when the interactive parameter is false. The core 206 in turn invokes a process stream off-core REST API at the data services 406. If the data stream status is active in the core 206 (shown in the portion 602 of the sequence diagram), the data services 406 returns that the process stream async call was successful in off-core (e.g., near-core), and the core 206 returns that the data stream run was successfully started. If the data stream status in inactive (shown in the portion 604), the core 206 returns a run data stream failed to the TUA 502.

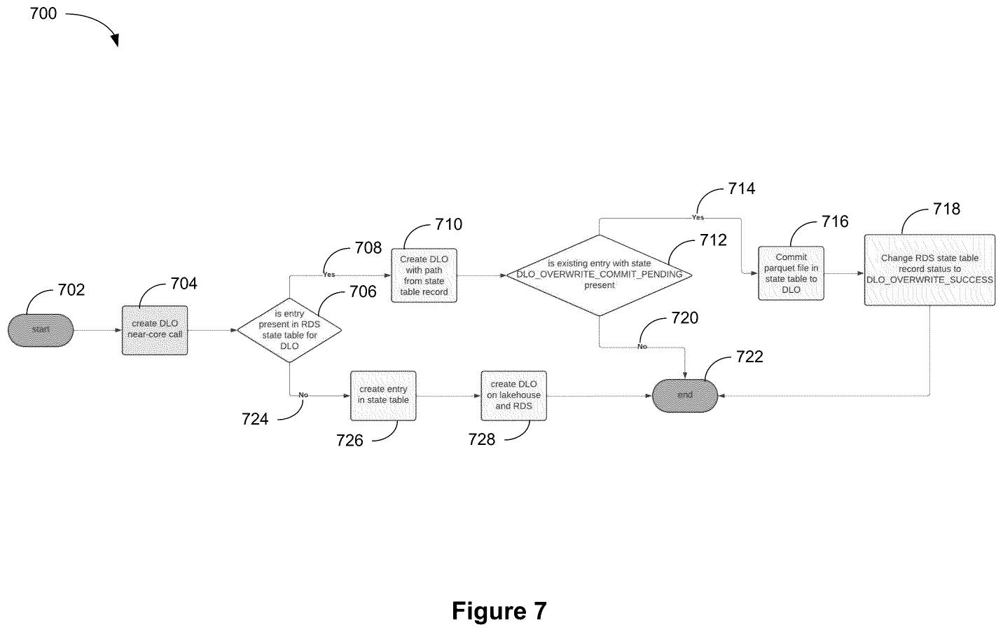

FIG. 7 is a flow diagram of an example process 700 for creating data lake objects, according to some implementations. The creation of a DLO at the near-core metadata controller 216 starts at 702. A DLO creation call 704 is received. Some implementations determine (704) is made regarding whether an entry is present in the RDS state table for the DLO (706). If the answer is no 724, then an entry is created in the state table for the DLO (726). Then, a DLO is created on a lake house and an RDS (728). If the answer is yes 708, then a DLO is created with a path from a state table record (710) and DLO creation process ends 722. Some implementations determine (712) whether there is an existing entry with a particular state (e.g., “DLO_OVERWRITE_COMMIT_PENDING”). If no 720, then the DLO creation process ends 722. If yes 714, then a Parquet file is committed in the state table to the DLO (716), and the RDS state table record status is changed (e.g., “DLO_OVERWRITE_SUCCESS”) (718).

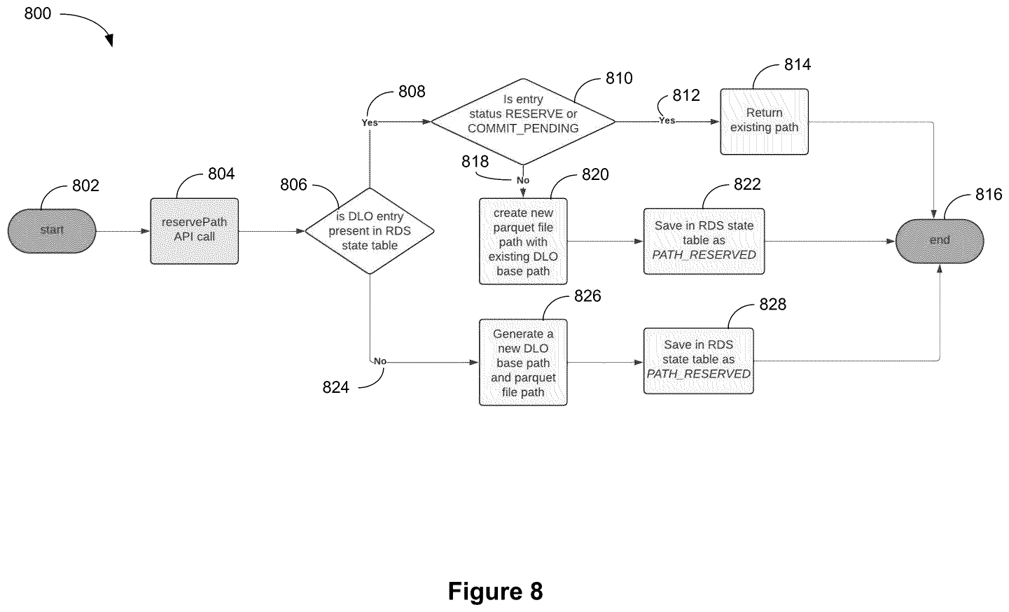

FIG. 8 is a flow diagram of an example process flow 800 for managing state tables for data lake objects, according to some implementations. The process flow begins at the near-core metadata controller 216 in step 802. A reserve Path API is called (804). In some implementations, the metadata controller 216 determines (806) whether a DLO entry is present in an RDS state table. If no 824, a new DLO base path and a Parquet file path is generated (826) and saved (828) in the RDS state table as reserved (e.g., “PATH_RESERVED”), and then the API call ends (816). If yes 808, some implementations determine (810) whether the entry status is reserved or pending a commit. If yes 812 (e.g., the entry status is reserved and/or pending a commit), then an existing path is returned (814), and the API call ends (816). If no, a new Parquet file path is created with the existing DLO base path (820) and saved (822) in the RDS state table as reserved (e.g., “PATH_RESERVED”), and the API call ends (816).

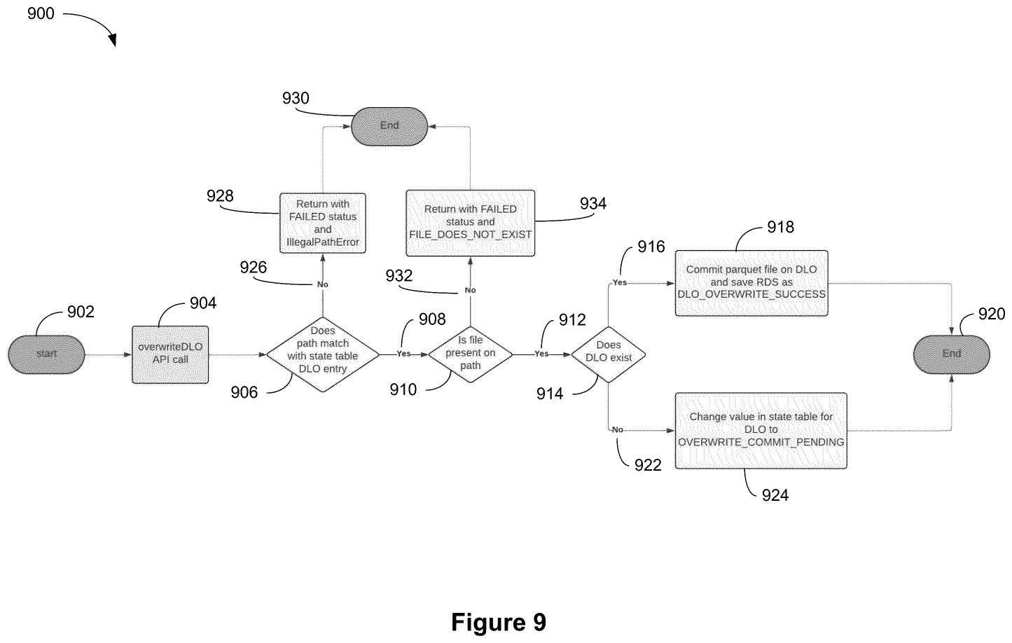

FIG. 9 is a flow diagram of an example process flow 900 for overwriting data lake objects, according to some implementations. The process flow begins at the near-core metadata controller 216 in step 902. A overwrite DLO API is called (904). A determination is made regarding whether the path matches with the state table DLO entry (906). If no 926, the overwrite DLO API returns a failed status and an illegal path error (928), and the API call ends (930). If yes, a determination is made regarding whether a file is present on the path (910). If no 932, the overwrite DLO API returns a failed status and a file does not exist error (934), and the API call ends (930). If yes 912, a determination is made regarding whether the DLO exists (914). If no 922, the value in the state table for the DLO is changed to “OVERWRITE_COMMIT_PENDING” (924), and then the API call ends (920). If yes (916), the Parquet file is committed on DLO and the RDS is saved as “DLO_OVERWRITE_SUCCESS” (918), and the API call ends (920).

### Example Computing Device for Concurrent Metadata and Data Processing

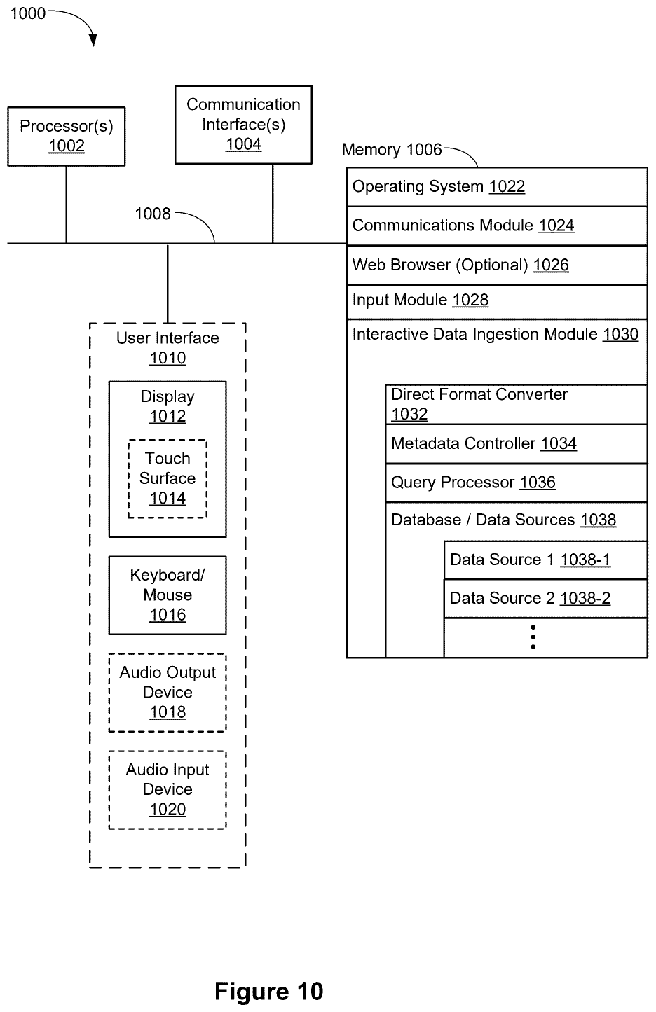

FIG. 10 is a block diagram of an example computing device 1000 for concurrent metadata and data processing in interactive data ingestion, according to some implementations. Computing devices 1000 include desktop computers, laptop computers, tablet computers, and other computing devices with a display and a processor capable of running a data visualization application. A computing device 1000 typically includes one or more processing units/cores (CPUs) 1002 for executing modules, programs, and/or instructions stored in the memory 1006 and thereby performing processing operations; one or more network or other communications interfaces 1004; memory 1006; and one or more communication buses 1008 for interconnecting these components. The communication buses 1008 may include circuitry that interconnects and controls communications between system components. In some implementations, the computing device 1000 includes a user interface 1010 comprising a display 1012, which may include a touch surface or touch screen display 1014, and/or one or more input or output devices or mechanisms (e.g., a keyboard/mouse 1016, an audio output device 1018, and/or an audio input device 1020). In some implementations, the display 1012 is an integrated part of the computing device 1000. In some implementations, the display is a separate display device. The input devices or mechanisms can be used to provide natural language commands directed to data sources 1038.

In some implementations, the memory 1006 includes high-speed random-access memory, such as DRAM, SRAM, DDR RAM or other random-access solid-state memory devices. In some implementations, the memory 1006 includes non-volatile memory, such as one or more magnetic disk storage devices, optical disk storage devices, flash memory devices, or other non-volatile solid-state storage devices. In some implementations, the memory 1006 includes one or more storage devices remotely located from the processors 1002. The memory 1006, or alternatively the non-volatile memory devices within the memory 1006, comprises a non-transitory computer-readable storage medium. In some implementations, the memory 1006, or the computer-readable storage medium of the memory 1006, stores the following programs, modules, and data structures, or a subset thereof:
an operating system 1022, which includes procedures for handling various basic system services and for performing hardware dependent tasks;
a communication module 1024, which is used for connecting the computing device 1000 to other computers and devices via the one or more communication network interfaces 1004 (wired or wireless) and one or more communication networks, such as the Internet, other wide area networks, local area networks, metropolitan area networks, and so on;
an optional web browser 1026 (or other client application), which enables a user to communicate over a network with remote computers or devices;
an input module 1028 to process input and/or signals received from the user interface 1010, and/or output signals to output devices in the user interface 1010;
an interactive data ingestion module 1030, which includes a direct format converter 1032 (e.g., the direct format converter 104), a metadata controller 1034 (e.g., the metadata controller 110), and/or a query processor 1036 (e.g., the query processor 108); and/or
zero or more databases or data sources 1038 (e.g., a first data source 1038-1), which are used by the module 1030. In some implementations, the data sources are stored as spreadsheet files, CSV files, XML files, flat files, JSON files, tables in a relational database, cloud databases, or statistical databases.

In addition to the modules and/or data structures described above, the memory 1006 stores additional modules and data structures that may be necessary for performing the operations described in reference to FIGS. 1-9, and FIG. 11, even if not explicitly described herein. Each of the above identified executable modules, applications, or set of procedures may be stored in any of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 1006 stores a subset of the modules and data structures identified above. In some implementations, the memory 1006 stores additional modules or data structures not described above. Although FIG. 10 shows a computing device 1000, FIG. 10 is intended more as a functional description of the various features that may be present rather than as a structural schematic of the implementations described herein. In practice, and as recognized by those of ordinary skill in the art, items shown separately could be combined and some items could be separated.

Each of the above identified executable modules, applications, or sets of procedures may be stored in one or more of the identified memory devices and corresponds to a set of instructions for performing a function described above. The modules or programs (i.e., sets of instructions) need not be implemented as separate software programs, procedures, or modules, and thus various subsets of these modules may be combined or otherwise re-arranged in various implementations. In some implementations, the memory 1006 stores a subset of the modules and data structures identified above. Furthermore, the memory 1006 may store additional modules or data structures not described above.

### Example Method for Concurrent Metadata and Data Processing

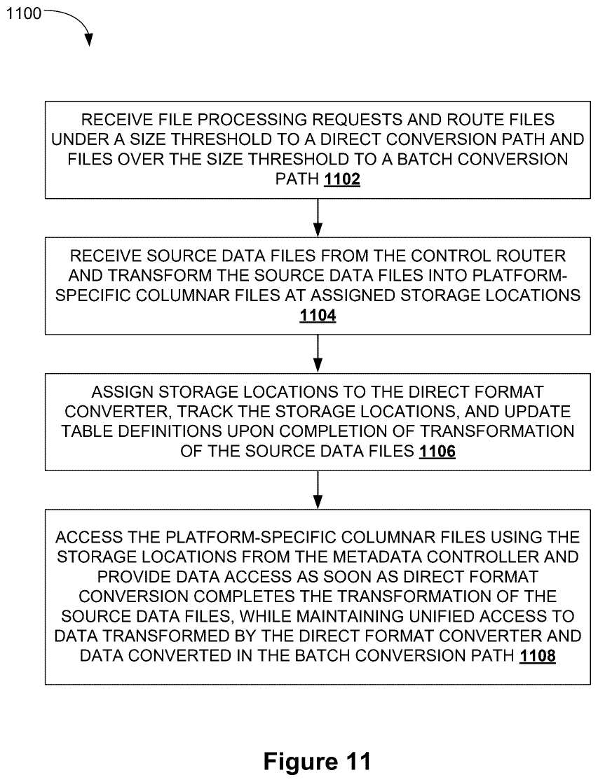

FIG. 11 is a flowchart of an example method 1100 for data ingestion, according to some implementations. The method 1100 can be performed by a data ingestion system (e.g., the system 100) or modules of the computing device 1000 described above.

The control router 102 receives (1102) file processing requests (e.g., the file processing requests 103) and routes files under a size threshold (e.g., 10 MB) to a direct conversion path (e.g., the direct format converter 104) and route files over the size threshold to a batch conversion path (e.g., the batch converter 105). For example, as described above in reference to FIG. 5, when a Tableau Unified Analytics (TUA) framework creates a data stream, the system checks if a source CSV file is less than or equal to 10 MB. If so, the file is routed to the direct path and if not, the data stream creation fails. In some implementations, the control router 102 also determines the conversion path based on measured file sizes and user-specified processing parameters. In some implementations, the control router 102 further manages file re-upload scenarios by directing updates to existing storage locations. In some implementations, the control router 102 further processes both synchronous and asynchronous conversion requests. For example, as described above in reference to FIG. 6, when TUA invokes a run data stream connect API at the core, the TUA can handle synchronous and asynchronous processing. The sequence shows how the system 100 handles active versus inactive data stream status differently, demonstrating support for both types of requests. In some implementations, the size threshold is 10 megabytes, such that files smaller than 10 megabytes are routed to the direct conversion path and files larger than 10 megabytes are routed to the batch conversion path.

The direct format converter 104 receives (1104) source data files from the control router and transforms the source data files into platform-specific columnar files at assigned storage locations (e.g., the assigned storage location 106). Platform-specific columnar files can include, for example, columnar files in formats specifically designed for the data platform, such as Parquet files with schema defined using Apache Arrow or Apache Avro, Arrow vectors that are columnar data structures holding data in a columnar format, and files optimized for in-memory processing and serialization/deserialization tasks. In some implementations, the direct format converter 104 also performs in-memory columnar data transformation. In some implementations, the direct format converter 104 further generates unique identifiers for each row during conversion. For example, as described above in reference to FIG. 4 (steps 7-11), when the direct format converter 404 converts a CSV file to a Parquet file, it evaluates and adds a UUID for each row as a primary key during the conversion process before writing to the data lake 408. In some implementations, the direct format converter 104 further validates schema consistency between source and destination formats.

The metadata controller 110 assigns (1106) storage locations to the direct format converter 104, tracks the storage locations, and updates table definitions upon completion of transformation of the source data files. In some implementations, the metadata controller 110 further maintains a state table tracking conversion status across concurrent operations. In some implementations, the metadata controller 110 further reserves storage paths before conversion begins and track path availability. For example, the state table can include a relational database table that tracks the status of file conversion operations through defined states including, for example: PATH_RESERVED: Initial state when storage path is allocated, DLO_OVERWRITE_COMMIT_PENDING: Waiting for commit operation, DLO_OVERWRITE_SUCCESS: Successful file conversion and storage, and DLO_OVERWRITE_FAILURE: Failed conversion attempt.

In some implementations, the metadata controller 110 further transitions through states comprising path reserved, commit pending, overwrite success, and overwrite failure. In some implementations, the metadata controller 110 further maintains cross-references between source files and converted files using unique identifiers. For example, in reference to FIG. 4 and FIG. 5, when a data stream and DLO are created, the system 100 maintains lineage tracking from visualization to a semantic data model (SDM) to DLOs to a data stream, establishing relationships between source and converted files. In some implementations, the metadata controller 110 further generates temporary credentials for storage access during conversion. For example, as described above in reference to FIG. 2, the core 206 and storage API retrieve temporary S3 credentials and send them via an S3 software development kit to the metadata controller 216, allowing secure access to storage locations. In some implementations, the metadata controller 110 further generates paths and update table definitions concurrently. In some implementations, the metadata controller 110 further executes both overwrite and append operations for converted data. For example, as described above in reference to FIG. 9, when an overwrite DLO API is called, the system 100 checks if the path matches with the state table entry, verifies file presence, and then either commits the Parquet file (overwrite operation) or changes the state to “OVERWRITE_COMMIT_PENDING” based on whether the DLO exists. In some implementations, the metadata controller 110 also validates schema consistency between the table metadata and the schema in the destination file format.

The query processor 108 accesses (1108) the platform-specific columnar files using the storage locations 106 from the metadata controller 110 and provides data access as soon as direct format conversion completes the transformation of the source data files, while maintaining unified access to data transformed by the direct format converter 104 and data converted in the batch conversion path. In some implementations, the query processor 108 further supports remote file refresh through app-driven (e.g., updates initiated by applications like Tableau Unified Analytics), query-layer-driven (e.g., updates triggered by query operations), and periodic refresh mechanisms (e.g., updates performed on scheduled intervals, e.g., every few hours). For example, in reference to FIG. 4, after a file is converted and stored in the data lake 408, the query service 338 can handle different types of refresh requests, whether initiated by the application, triggered by queries, or scheduled periodically. In some implementations, the query processor 108 further maintains shadow extracts for remote file sources. For example, as described above in reference to FIG. 4, after the Parquet file is written to the data lake 408, the system maintains a .hyper file (shadow extract) containing the data of the remote file to facilitate querying. Shadow extracts can include maintained copies of remote file sources, for example: .hyper files containing the data of remote files, data used to facilitate query operations, data that enables faster query processing without accessing remote sources,

The direct format converter 104 and metadata controller 110 are further configured to operate concurrently (e.g., through coordinated storage location handoffs). Coordinated storage location handoffs refers to the orchestrated process between the direct format converter 104 and the metadata controller 110 to manage storage locations during file conversion. The process begins when the direct format converter 104 needs to write a converted file, for example. For instance, as described above in reference to FIG. 4, the direct format converter 404 invokes an API from the metadata controller 216 to acquire a path to the data lake 408 before writing the converted Parquet file. This ensures proper storage coordination. The direct format converter 104 first calls an API from the metadata controller 110 to obtain a valid path in the data lake. The metadata controller 110 handles this request differently depending on whether a data lake object (DLO) exists. If no DLO exists, the metadata controller 110 generates a new table path and tracks it in its relational database service (RDS). If a DLO already exists, the metadata controller 110 simply returns the existing path. After the direct format converter 104 receives the path, the direct format converter 104 can write the converted file to that location. After successfully writing the file, the direct format converter 104 can make a second API call back to the metadata controller 110 to signal completion and trigger the necessary metadata operations.

In some implementations, the direct format converter 104 further performs schema inference on source files before conversion. For example, in reference to FIG. 3, when the UI client requests schema analysis of an uploaded file, the connector APIs work with the data connectors service to analyze and infer the schema structure before any conversion. In some implementations, the direct format converter 104 further executes within a containerized environment supporting horizontal scaling. For example, in FIG. 4, the format conversion service (the direct format converter 404) operates as a Java-based service that can be managed and scaled using Kubernetes, allowing it to handle multiple conversion requests simultaneously. A containerized environment can be a Java-based environment, managed and/or scaled using Kubernetes, capable of handling multiple conversion requests simultaneously, and/or support horizontal scaling for increased loads.

In some implementations, the metadata controller 110 maintains a state table to track the status of these operations, transitioning through states (e.g., PATH_RESERVED, DLO_OVERWRITE_COMMIT_PENDING, DLO_OVERWRITE_SUCCESS, and DLO_OVERWRITE_FAILURE). For example, as described above in reference to FIG. 8, when a reserve Path API is called, the metadata controller 110 checks if a DLO entry exists in the RDS state table. Based on this check, the metadata controller 110 either creates a new path or returns an existing one, maintaining states like “PATH_RESERVED” throughout the process. This coordinated handoff process can ensure that storage locations are effectively managed and tracked while enabling concurrent operations. It prevents conflicts that could arise from simultaneous file conversions and maintains data consistency by keeping the metadata and actual file locations synchronized. In this way, the system 100 can handle multiple file conversions efficiently while maintaining a reliable record of where everything is stored.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A data ingestion system, comprising:
a control router configured to:
receive file processing requests and route files under a size threshold to a direct conversion path and files over the size threshold to a batch conversion path;
a direct format converter configured to:
receive source data files from the control router and transform the source data files into platform-specific columnar files at assigned storage locations;
a metadata controller configured to:
assign storage locations to the direct format converter, track the storage locations, and update table definitions upon completion of transformation of the source data files; and
a query processor configured to:
access the platform-specific columnar files using the storage locations from the metadata controller and provide data access as soon as the direct format converter completes transformation of the source data files, while maintaining unified access to data transformed by the direct format converter and data converted in the batch conversion path.

2. The data ingestion system of claim 1, wherein the control router is further configured to determine the conversion path based on measured file sizes and user-specified processing parameters.

3. The data ingestion system of claim 1, wherein the direct format converter is further configured to perform in-memory columnar data transformation.

4. The data ingestion system of claim 1, wherein the metadata controller is further configured to maintain a state table tracking conversion status across concurrent operations.

5. The data ingestion system of claim 1, wherein the direct format converter is further configured to generate unique identifiers for each row during conversion.

6. The data ingestion system of claim 1, wherein the metadata controller is further configured to reserve storage paths before conversion begins and track path availability.

7. The data ingestion system of claim 1, wherein the metadata controller is further configured to execute both overwrite and append operations for converted data.

8. The data ingestion system of claim 1, wherein the metadata controller is further configured to transition through states comprising path reserved, commit pending, overwrite success, and overwrite failure.

9. The data ingestion system of claim 1, wherein the direct format converter is further configured to validate schema consistency between source and destination formats.

10. The data ingestion system of claim 1, wherein the control router is further configured to manage file re-upload scenarios by directing updates to existing storage locations.

11. The data ingestion system of claim 1, wherein the query processor is further configured to support remote file refresh through app-driven, query-layer-driven, and periodic refresh mechanisms.

12. The data ingestion system of claim 1, wherein the direct format converter is further configured to perform schema inference on source files before conversion.

13. The data ingestion system of claim 1, wherein the metadata controller is further configured to maintain cross-references between source files and converted files using unique identifiers.

14. The data ingestion system of claim 1, wherein the direct format converter is further configured to execute within a containerized environment supporting horizontal scaling.

15. The data ingestion system of claim 1, wherein the metadata controller is further configured to generate temporary credentials for storage access during conversion.

16. The data ingestion system of claim 1, wherein the query processor is further configured to maintain shadow extracts for remote file sources.

17. The data ingestion system of claim 1, wherein the metadata controller is further configured to generate paths and update table definitions concurrently.

18. The data ingestion system of claim 1, wherein the control router is further configured to process both synchronous and asynchronous conversion requests.

19. A method for data ingestion, comprising:
at a computing device having one or more processors, and memory storing one or more programs configured for execution by the one or more processors:
at a control router:
receiving file processing requests;
determining sizes of files associated with the file processing requests; and
routing files under a size threshold to a direct format converter and files over the size threshold to a batch converter;
at the direct format converter:
transforming source data files into platform-specific columnar files; and
storing the transformed source data files at assigned storage locations;
at a metadata controller:
assigning storage locations for the transformed files;
tracking the storage locations;
updating table definitions upon completion of transformation of the source data files; and
at a query processor:
accessing the platform-specific columnar files using the tracked storage locations;
providing data access upon completion of file transformation; and
maintaining unified access to data transformed by both the direct format converter and batch converter.

20. A non-transitory computer readable storage medium storing one or more programs, the one or more programs configured for execution by a computing device having one or more processors, and memory, the one or more programs comprising instructions for:
at a control router:
receiving file processing requests;
determining sizes of files associated with the file processing requests; and
routing files under a size threshold to a direct format converter and files over the size threshold to a batch converter;
at the direct format converter:
transforming source data files into platform-specific columnar files; and
storing the transformed files at assigned storage locations;
at a metadata controller:
assigning storage locations for the transformed files;
tracking the storage locations;
updating table definitions upon completion of transformation of the source data files; and
at a query processor:
accessing the platform-specific columnar files using the tracked storage locations;
providing data access upon completion of file transformation; and
maintaining unified access to data transformed by both the direct format converter and batch converter.
